(19) United States
(12) Patent Application Publication
(10) Pub. No.: US 2022/0217817 A1
(43) Pub. Date: Jul. 7, 2022

(54) SPECIAL ELECTRODE ARRANGEMENT FOR THE TARGETED OHMIC HEATING OF DIFFERENT PRODUCTS OR STRUCTURES THAT ARE ELECTRICALLY CONDUCTIVE OR CONTAIN ELECTRICALLY CONDUCTIVE CONSTITUENTS

(71) Applicant: Fritz Kortschack, Oldenburg (DE)

(72) Inventors: Fritz Kortschack, Oldenburg (DE); Kevin Eberhardt, Sachsen bei Ansbach (DE)

(21) Appl. No.: 17/607,167

(22) PCT Filed: Mar. 25, 2020
(86) PCT No.: PCT/EP2020/058293

§ 371 Date: Oct. 28, 2021

(30) Foreign Application Priority Data
Apr. 29, 2019 (DE) 10 2019 110 939.6
Oct. 17, 2019 (DE) 10 2019 128 106.7

(51) Int. Cl. H05B 3/00; H05B 3/03

(52) U.S. Cl. CPC H05B 3/0004; H05B 3/03

(57) ABSTRACT

The invention relates to a special electrode arrangement for the targeted ohmic heating of different inorganically or organically based products or structures that are electrically conductive or contain electrically conductive constituents, including products of plant or animal origin, consisting of at least one group of electrodes comprising at least two individual electrodes, formed as puncturing or penetrating electrodes. The puncturing or penetrating electrodes are electrically insulated from one another and likewise designed to be insulated with respect to the product or the structure to be treated, with the exception of a portion of the surface or of the electrode tip.

The invention relates to a special electrode arrangement for targeted ohmic heating of different inorganically or organically based products or structures that are electrically conductive or contain electrically conductive constituents including products of plant or animal origin, consisting of at least one electrode group comprising at least two individual electrodes formed as puncturing or penetrating electrodes according to claim 1.

A device for electrically rapidly heating foodstuffs is already known from DE 15 40 909 A, wherein the heating is performed by high-frequency alternating current passing axially through a corresponding foodstuff. The alternating current is supplied by contacts at the ends or front sides of the oblong foodstuff to be treated. The relevant non-conducting or poorly conducting casing of the foodstuff is penetrated. The electrodes employed can have point-shaped or cutter-shaped protrusions at the contact surfaces so that the casing can be easier punctured.

The matter in the device for heating foodstuffs according to DE 10 2015 206 385 A1 preferably is treating wrapped products, in particular meat and sausage products. This teaching intends to realize a rapid heating of the wrapped foodstuff by means of uniformly applying electrical current, which generates heat within the foodstuff.

The known device has at least two spaced, axially parallel and accordantly rotatable cylindrical electrodes, which are contacted to the connections of opposite polarity of an electrical current source and are in electrical contact with the casing, wherein the electrodes rotate at the casing. The current source according to DE 10 2015 206 385 A1 provides alternating current having a frequency in the range from 2 kHz to 300 MHz.

The document DE 10 2014 010 166 A1 takes a method for treating a foodstuff by heating as a basis. In this case, non-conventional ohmic heating is used.

The functional principle of ohmic heating refers to directly conducting current through the product. In this case, the foodstuff quasi adopts the function of a resistor.

According to DE 10 2014 010 166 A1, filling of a dimensionally stable casing of a non-conducting material or which is dimensionally stabilized by further means, with a filling material is first performed. In this case, it may be sausage meat or a similar foodstuff raw material. Following this, the openings of the casing are closed by means of conducting surfaces, in particular plates or plugs. The electrical current is supplied over the conducting surfaces for the purpose of ohmic heating.

In a configuration according to DE 10 2014 010 166 A1, the product of treatment can be partitioned into sections within the casing by conducting boundaries, for example, discs of conducting material. These conductive boundaries result in a homogenization of the current flow and thus in a uniformization of the ohmic heating.

All of the above-mentioned solutions have in common that the heating by ohmic heating depends on the conductive paths within the product to be treated, i.e. the product resistance. Usually, this resistance is not homogenously distributed over the volume of the good or product to be treated. This results in greater currents flowing in partial branches of lower resistance, with the result of excessive heating in these branches, and insufficient heating or overly prolonged treatment time in branches of higher resistance.

From the aforementioned, it is therefor a task of the invention to propose a special electrode arrangement, which avoids the shortcomings of the state of the art and allows novel, hitherto unknown fields of applications for the technological area of ohmic heating.

The solution of the task of the invention is performed according to the electrode arrangement in the feature combination according to claim 1, as well as with regard to the autonomous applications in this respect according to the teaching of claim 14, however, without being limited to these applications mentioned explicitly there.

Accordingly, a special electrode arrangement for the targeted ohmic heating is taken as a basis. In this case, different inorganically or organically based products or structures that are electrically conductive or contain electrically conductive constituents are intended to be treated. Likewise, the treatment of products of plant or animal origin is intended to be possible. The electrode arrangement consists of at least one electrode group comprising at least two individual electrodes formed as puncturing or penetrating electrodes.

Preferably, a plurality of electrode groups each having a plurality of individual electrodes is provided so as to be able to heat or treat spatially or, as far as the volume is concerned, larger products or structures sufficiently by ohmic heating in a technologically appropriate short time.

According to the invention, the puncturing or penetrating electrodes, only referred to as electrodes below, are electrically insulated from one another and likewise designed to be insulated with respect to the product or the structure to be treated, with the exception of a portion of the surface or of the electrode tip.

These electrodes according to the invention can be introduced below the surface of the product to be treated, i.e. preferably be inserted into the volume. Current paths will then form within the volume of the product of treatment, which leads to an improvement of the results of ohmic heating.

The electrodes according to the invention can be combined with the electrodes of the state of the art depicted in the introductory description, in particular with such electrodes, which rest upon the surface of a product of treatment or only penetrate on the volume or surface side in a minimum manner.

The formation of the electrodes according to the invention enables ohmic heating in combination with further well-known methods of treating products, such as, for example, the so-called electric perforation of plant or animal cells and products to be treated accordingly, the treatment by means of high pressure for reducing germs and/or the treatment by means of ultrasound for modifying the structure of the product of treatment, for example, for compacting.

If, for instance the electrode arrangement is applied in conjunction with the technology of ohmic heating and subsequently or simultaneously with an electric perforation, cell walls can be broken and the broken state can be maintained. Furthermore, cell liquid is released, which in turn reduces the resistance value of the product of treatment with the further consequence of a potential reduction but also shortening of the treatment time for ohmic heating.

In a further development of the invention, the electrode arrangement has an electrode group consisting of a plurality of mutually insulated individual electrodes having a brush-like or comb-like formation. The individual electrodes optionally are interconnectable and electrically controllable either directly individual or in a subset of the individual electrodes.

Due to this individual interconnectivity of the individual control abilities of the electrodes of an electrode group allows changing resistance values or resistance values decisive for the product or structure to be responded to.

Here is also the possibility to initially use such an electrode group as measurement electrodes so as to determine a surface resistance or a specific resistance and its changing over a surface, in order to initiate thereafter the control of the electrodes in such a manner that the desired product quality is reached or remains assured.

In a further embodiment of the invention, the individual electrodes are formed to be oblong and needle-like, provided with a tip, wherein the electrical insulation can be conducted up into the tip area, the tip, however, remaining free in the electrical sense.

The individual electrodes can be disposed to be relatively moveable in a casing surrounding the electrodes.

The casing can in this case have the action of insulation. An individual electrode retracted into the casing can be introduced into the volume. Retracting the casing or extending the corresponding electrode depending on the dimension of the exposed electrode and the resulting contact transition resistance to the product to be treated, allows the treatment to be optimized and controlled.

The surrounding casing may also simplify the introduction of the corresponding electrode into a product to be treated. And that to an extent that a very thin needle-like electrode is no longer exposed to the risk of being destroyed or warped or damaged otherwise. The casing serves in this case not only as an insulation casing but also as a mechanical stabilization, in particular during the operation of puncturing or penetrating into the product of treatment.

When the corresponding electrode has reached its end position, the casing can be pulled back in fact before the actual thermal treatment, i.e. the ohmic heating begins. Treatment traces by recognizable puncturing paths or puncturing channels can be avoided.

The individual electrode may furthermore be configured as an oblong, hollow-cylindrical structure, wherein a medium is suppliable or injectable into the product of treatment or the structure to be treated via the hollow cylinder during the treatment or else after a performed treatment.

For this purpose, the individual electrode itself may have a hollow-cylindrical passage in this respect. But alternatively, there is also the possibility to form an intermediate space between the already mentioned surrounding casing and the electrode, which serves for the supply of corresponding fluidic media, i.e. gaseous or liquid substances.

In a further configuration according to the invention, the individual electrode may be a component of a shaping body with respect to a product of treatment or a shaping casing, wherein the individual electrodes with respect to the body or the casing can be movably shifted towards it. Thus, the product to be treated can be introduced into the shaping body. In the next step, the electrodes can then be brought into their desired treatment positions, and the treatment on the basis of ohmic heating can begin.

In this case, there is the further possibility to shift the electrodes during the treatment in their positions relative to the shaping body and thus to the product to be treated, for example, to slowly retract them into their initial position so as to continue the heating treatment towards the outside as seen from the inner volume.

The shaping body or the casing can be configured to be applied with pressure or be in association with an ultrasound-generating means so as to enable a treatment of the product in conjunction with the ohmic heating in this respect.

The puncturing electrodes may consist of a metallic material, of conductive plastics or conductive ceramics or contain such materials. In this case, special aspects of the product of treatment can be taken into account, for example, according to legal regulations in foodstuff technology but also according to the provisions and regulations in treating human or animal tissue, in particular with respect to forming sterile or sterilizable electrodes.

The electrodes can consist of a core material having a conductive coating, wherein the so-called skin effect is aimed at via the conductive coating during a corresponding alternating current treatment of the product of treatment. Insofar, only the conductive coating needs to be realized to be as highly conductive as possible. The electrode core or the material receiving and carrying the casing may be selected or optimized under a mechanical aspect but also under the cost aspect.

As already briefly mentioned, the electrode arrangement according to the invention may be in association with a device for electric perforation (PEF), wherein at least one electrode is a component of the electric perforation device or can at least temporarily be interconnected in this respect.

The special electrode arrangement according to the invention for targeted ohmic heating is in particular used in the field of foodstuff technology, for the surgical treatment of humans or animals, in the building industry for drying buildings or building parts, in the catering trade for heating foodstuffs, for drying or compacting biological or chemical wastes, but also in the field of heating and air-conditioning technology.

The invention will be explained in more detail below by means of exemplary embodiments and further advantages as well as of application aspects.

In the field of surgical, respectively medical treatment of humans or animals, the special electrodes with needle-shape may serve to denaturize tissue by targeted heat application. This may be done in a minimally invasive manner.

A particular advantage is that, when miniaturized needle electrodes are used, only a small area penetrates into the tissue to be treated, which minimizes the treatment risk and improves the treatment success. Side effects by cuts or germs introduced during surgery can be reduced.

The special electrode arrangements, in particular in a brush or comb shape, can be disposed to be circular, for example. The insulation of the electrodes is in this case configured such that the product of treatment and subjected to ohmic heating represents a sphere. Interconnected electrodes allow the product of treatment to be treated little by little depending on demands with a deviating or enforced intensity.

In this respect, the individual electrodes can be activated in a switching circuit technological manner without an electrode change occurring so as to reach, for example, layers outside the shaping to be treated. But alternatively, there is also the possibility to exchange an electrode, for example, guided in a casing by an electrode of another geometry.

The treatment zones may map any desired shape such as, for example, rectangles, stripes, layers, tubes, round bars or figures symbolizing a certain occasion such as, for example, a Santa Claus, an Easter Bunny, a logo of a heart, or etc.

In the technical field, there is the possibility to activate adhesives or curing filling masses or similar by areal or punctual heating by means of the electrode arrangement in a targeted manner. Due to the use of hollow needles, prior to, during or after the ohmic heating, substances, e.g. catalysts, can be injected into the product of treatment in a targeted manner through the hollow needles and likewise be thermically treated.

The treatment of a product is also possible in a special mold, a shaping body. Here, the electrodes may already be implemented within the mold or within the body, or may be introduced into the product of treatment or also be retracted again by means of breakthroughs in the mold.

The mentioned treatment may also take place in an open mold so that within the mold or after ejecting the product of treatment, a surface treatment by additional means such as, for example by wetting with liquid smoke, spice addition, color, but also by heating in the form of burning off, frying or by means of cold treatment may be performed.

For influencing the density of the product of treatment, the product may be subjected to a positive or negative pressure during the treatment by means of ohmic heating.

Due to positive pressure, a more solid consistency is generated and prevents cavities from being formed within the product, i.e. the product of treatment, in which liquid may undesirably collect with the result of a changed or even interrupted current flow.

In an application by negative pressure, a desired foamy or fluffy consistency of the product of treatment may be stabilized or achieved such as it is required, for example, in bread, cake, parfait or similar preparations.

Sausage meat mass may be filled loosely into a current-permeable casing (a natural casing). This is then sucked, inserted or layered into a negative mold.

By putting on a closely sealing cover mold and applying a vacuum within the intermediate space, the filling product positioned within the casing expands and is delimited by the casing itself.

By means of adapted electrodes in the interior of the intermediate space, the expanded mass may be heated and thus dimensionally stabilized by means of ohmic heating.

In a similar manner as explained above, sausage meat may be introduced into a negative mold. By putting on a sealing cover mold and applying a vacuum, the product of treatment may be subjected to expansion delimited by the molds. The application of alternating current into the product of treatment by means of the contacts positioned within the intermediate space then leads to the ohmic heating, with the result of dimensionally stabilizing the product to be treated.

The product of treatment may have a direct contact with the mold, for example, in the form of skin-free sausage, but may also be in a non-conducting shell, for example, for a pâté or similar.

During the treatment of single zones within the product of treatment by electrodes introduced into the volume, there is the possibility to realize different densities within the product of treatment by changing the pressure, which results in the specific resistance changing in this area. Here, an adaptation of the application of alternating current may then be performed, so as to shorten the treatment time with the same result, or else to intensify a treatment.

It is within the filed of application of the invention to encase temperature-sensitive drugs by a mechanically more solid layer which can be brought to higher temperatures, or vice versa. In this respect, as well, a solidification of the casing may be performed by ohmic heating.

In case of a product of treatment positioned in closed or open molds, such as, for example, cold cut meat, sausage meat, pickled meat for boiled ham production, smoked pork chop raw products or non-pretreated roast pieces, a heating may be performed with the aid of brush electrodes or comb electrodes even at problematic positions such as curves, for example. In this case, the brush electrodes may form a geometric casing curve corresponding to the structure or the shape of the product to be treated so that a corresponding uniform penetration into the volume may be performed.

Inserted molds may be joined to one another so as to simplify a treatment of small-sized products.

Boiled sausage meat or bratwurst meat may be filled into joined lower molds. Air above the product of treatment is removed prior to putting on the exactly fitting mold covers provided in particular with brush electrodes, so that during the treatment of ohmic heating, the sausage meat is exposed to pressure and in the final product, a solid air pocket-free consistency is present.

After such a treatment, which is also suitable for sausage meat positioned within a casing, the warm raw products may be surface treated or be packed in a warm untreated state. In case of sausages, the surface treatment may be performed by liquid smoke. For the final germ reduction of the packed products, a possibly further, short-term heat treatment takes place.

While using the electrodes according to the invention, it is possible at the shop counter or in the catering trade, for example, to heat roast, prepared food or the like only in sections. The indirect, rather rapid heating prevents products to be distributed in a warm state are required to be prepared in a warm state over a partially very long period of time, such as it is the case with meals on wheels, and possibly are no longer usable later, for example, after closing of the canteen.

In contrast to the hitherto known heating methods, the heating according to the invention does not take place from the outside to the inside but at the same time and homogenously in the entire product of treatment. Therefore, no areas are formed which are exposed to a prolonged of too intensive heat. Also, with respect to a microwave treatment, the penetration depth of which is delimited, the ohmic heating according to the invention exhibits remarkable advantages such as, for example, reduced process time in case of larger calibers, reduced process loss and uniform heat penetration within the product of treatment.

Foodstuffs may be subjected to electric perforation (PEF treatment) prior to the treatment by means of ohmic heating. The heating occurring during such a treatment is harmless for further treatment or desired for pre-heating the raw product. By the PEF treatment, holes are generated in the cell membranes. Through the association of extracellular liquid and intracellular liquid, the bonding capacity, i.e. the consistency of the product is increased, for example, in a boiled sausage meat. The stabilizing substances such as phosphate, milk protein or the like may be reduced and, depending on the recipe, may even be omitted completely.

The advantage of this combined treatment is the fact amongst others that microorganisms are damaged at least sublethally by the PEF treatment.

Since cell tissues after some time, due to quasi self-healing powers, tend to close again the perforations caused in the cell wall, a PEF treatment with a subsequent heat treatment on the basis of ohmic heating is advantageous. The protein coagulation occurring in this case prevents the cell perforations from closing again.

Before rigor mortis sets in, an undesired muscle shortening may be prevented by applying the ohmic heating in meat at slaughter temperature, and thus the tenacity of the raw product may be influenced.

Since warm meat reacts very sensitively to external influences such as coldness, heat, electrostimulation or the like by muscle shortening before rigor mortis sets in, a corresponding ohmic heat in the warm meat in combination with a pressing power is advantageous, namely for preventing muscle shortening after the slaughter process by the meshing of filaments.

If warm meat is clamped in an intrinsically known pressing device in such a manner that the filaments cannot mesh, this state can be quasi preserved and frozen when an ohmic heating takes place by electrodes of the type according to the invention, and hereby the protein of the product of treatment coagulates thus far that a biochemical change of the muscles can no longer take place after the meat has been removed from the pressing device.

The method mentioned above offers many advantages such as short process times, low drying losses, smaller storage surfaces, and a lower microbial load.

The ohmic heating can be combined with the PEF treatment mentioned above, which contributes to damaging microorganisms despite the relatively low thermal alteration in such a manner that a propagation of these undesired microorganisms is prevented or delayed.

The combination of the PEF treatment with ohmic heating makes shortly ripened raw sausages safer in that salmonella, listeria, viruses or the like are inactivated.

The ohmic heating on the basis of the presented electrodes quite fundamentally offers itself for inactivating spore formers. By heating a product of treatment almost at all points simultaneously and very rapidly, current-conducting products, such as, for example wetted herbs are heated inside the product to an extent that germinating of spore formers is provoked due to the occurred stress by the heat treatment. The product treated in such a manner undergoes a significant reduction in germs by means of a subsequent, time-delayed renewed heat treatment by means of ohmic heating at higher temperatures, which again acts rapidly in the entire product of treatment, namely by damaging and inactivating the germinated spores.

Here, it is also possible to subject the product of treatment promptly to a high-pressure treatment for inactivating or damaging the germinated spores.

This high-pressure treatment may also be performed at the beginning of the treatment chain and encourage the spore formers to germinate by stress.

By the heat progression from the outside to the inside, hitherto known heating methods lead to the fact that at least a part of the spores is able to prepare for the subsequent heat treatment and an undesired encapsulation occurs.

The heat treatment mentioned above by means of ohmic heating may take place before a PEF treatment.

A supplementary variant of application using ohmic heating on the basis of the electrode arrangement according to the invention is to heat the product to be treated directly in a package.

When the product of treatment, for example, is filled in a recessed open mold, the product may be heated by several needle-like pin electrodes as desired, contacting, however not puncturing the bottom of the mold through the product of treatment.

For surface treating the product of treatment, smoke, herbs or similar may be applied internally to the mold. After the filling and heating process, a cover or a cover foil may be pulled upon the mold. The coating of the cover may be performed in a similar form as the internal coating of the mold. By means of a shrinking process of the foils performed by the heat treatment, introduced germs may be minimized or eliminated.

But even a product already situated in an encasing may be treated by means of using needle electrodes or pincushion electrodes. The electrodes puncture the encasing at defined points, with the result of penetration into the filling mass and the heating then resulting from the application of current on the basis of ohmic heating. Reheating the product situated within the encasing is likewise possible.

A crushed product, for example, for raw sausage, may be tumbled in a device for disintegrating meat protein or may be subjected to a vibration process in a corresponding device. After this treatment, the material may be filled within a cartridge and experience compaction under vacuum. It is furthermore possible to perform the pretreatment directly in the cartridge.

As soon as the product of treatment is within the cartridge, ohmic heating to about 21° C. may be performed via puncturing electrodes.

After the puncturing electrodes have been removed, the needle holes can be closed. Until the further treatment step, the cartridges tightly closed in this manner may be stored for one or more days in a preset ambient temperature. This may be performed in a water bath but also under room air conditions. After reaching the isoelectric point of pH about 5.2, the compacted raw product may be ejected from the cartridge and subjected to further ripening or drying, but may also be smoked or surface treated in another manner.

For avoiding cavities or placeholder traces in the product treated by the ohmic heating by means of electrodes, extremely thin needles may be used which are only surrounded by a casing during the process of puncturing.

The risk that in this respect displacement traces of larger, thicker or more voluminous electrodes can be found in the solidified product is thereby extremely minimized.

As already discussed, during penetrating or entering into the mass of treatment, these very thin electrodes are protected against warping, breaking or deforming by a more stable encasing.

Prior to the treatment on the basis of ohmic heating, this encasing is again extracted from the product of treatment. The product will then occupy the released space so that only the very thin electrode remains within the product of treatment during the treatment, and thereafter may be removed easily from the product without leaving recognizable traces.

For forming a cap shape of the product of treatment, such as, for example, in sausages, there is the possibility to arrange several puncturing electrodes disposed in in an arc or shell shape or arch form within the ends of the product that are intended to be shaped.

Starting with a furthest distance, these special electrodes may be successively activated and connected to a current supply. For preventing the electrodes from mutually influencing one another, these may be insulated from one another for a short time or even over a longer period of time via a movable casing. A similar effect can be achieved when the special electrodes, in particular needle electrodes, are guided one after the other through the product surrounded by a non-conducting mold.

It is in the spirit of the invention to check a basic product, for example, a basic sausage meat, for its electrical characteristics. This check may be performed directly after withdrawal from a cutter. In this respect, usual resistance measurement devices may be used. Alternatively, however, the special electrodes according to the invention may fulfill a double function in that a resistance determination is performed before a treatment current is applied. After the resistance value has been determined, a current flow that is specific for the product of treatment is then set, and the electrodes are activated with the target of the desired ohmic heating.

In order to configure a structure, for example a sausage, to be cap-shaped at the ends and to stabilize it in this respect, cap electrodes may initially be activated. This results in a primary solidification in the edge or cap areas or at the sausage ends. Thereafter, further ohmic heating may be initiated via additional electrodes. The heating process, especially the one at the caps, may be monitored by a check on the basis of an infrared camera and be controlled, if necessary.

The layout of contacts at or for rounded cap ends is in particular ring-shaped. In this case, a concentric arrangement of corresponding rings, but also a segmented configuration in the form of segments of a circle may be performed. A center point contact may be realized to be punctiform.

But also selected contacts of a planar electrode may be interconnected with a plurality of individual electrodes for the purposes of achieving a brush shape in such a manner that a ring, a circular ring or a circular segment can be approximated so as to make in this respect a targeted and reinforced treatment in selected sections.

One application possibility of the presented electrode for ohmic heating is to dry substances carrying or containing moisture. Here, for example, soaked building materials may be dried by introducing electrodes. The electrodes may in this case be utilized with further conductive components within the building. There is also the possibility to introduce relevant electrodes as a precaution already when concreting is performed on site or a screed layer is created.

On the basis of a layer deliberately containing moisture, for example a sand or gravel layer situated within a corresponding trough or in an enclosed room, a heating system formed, for example, as a floor heating system may be implemented while considering low electrical voltages.

Ohmic heating basically can be designed to last permanently, for example, by a direct current flow through a flowable product to be heated, for example, for providing hot water. In this case, however, the relevant electrical safety regulations must be taken into account.

1. A special electrode arrangement for targeted ohmic heating of different inorganically or organically based products or structures that are electrically conductive or contain electrically conductive constituents including products of plant or animal origin, consisting of at least one electrode group comprising at least two individual electrodes formed as puncturing or penetrating electrodes,
characterized in that
the puncturing or penetrating electrodes are electrically insulated from one another and likewise designed to be insulated with respect to the product to be treated or the structure to be treated, with the exception of a portion of the surface or of the electrode tip.

2. The electrode arrangement according to claim 1,
characterized in that
the electrode group comprises a plurality of mutually insulated individual electrodes having a brush-like or comb-like formation and the individual electrodes optionally interconnectable and electrically controllable either directly individually or in a subset of the individual electrodes.

3. The electrode arrangement according to claim 1,
characterized in that
the individual electrodes are formed to be oblong and needle-like, provided with a tip, wherein the electrical insulation is conducted up into the tip area, or the tip is realized so that it can be left free.

4. The electrode arrangement according to claim 1,
characterized in that
the individual electrodes are disposed to be relatively moveable in a casing surrounding the electrodes.

5. The electrode arrangement according to claim 4,
characterized in that
the surrounding casing is realized to be retractable with the result of an exposed or exposable individual electrode.

6. The electrode arrangement according to claim 1,
characterized in that
the individual electrode is configured as an oblong, hollow-cylindrical structure, wherein a medium suppliable or injectable into the product or the structure via the hollow cylinder during the treatment or in a preliminary stage of a treatment.

7. The electrode arrangement according to claim 1,
characterized in that
the individual electrodes are a component of a shaping body with respect to the product of treatment or a shaping casing, wherein the individual electrodes with respect to the body or the casing are realized be movable towards it.

8. The electrode arrangement according to claim 7,
characterized in that
the body or the casing is designed to be pressurized.

9. The electrode arrangement according to claim 1,
characterized in that
the single electrodes consist of a metallic, electrically conductive material, of conductive plastics or conductive ceramics or contain such materials.

10. The electrode arrangement according to claim 1,
characterized in that
the individual electrodes consist of a core material having a conductive coating or casing, wherein the so-called skin effect aimed at via the conductive coating or casing and during application of alternating current to the product of treatment.

11. The electrode arrangement according to claim 1,
characterized in that
these are introduced or are introducible as ring electrodes for being introduced into or for forming an insulating cap that is shaping with respect to the product to be treated.

12. The electrode arrangement according to claim 1,
characterized in that
at least one of the individual electrodes is formed as an electrode for measuring physical or electrical characteristics of the product of treatment.

13. The electrode arrangement according to claim 1,
characterized in that
it is in association with a device for electric perforation, wherein at least one electrode is a component of the electric perforation device or can be interconnected with such an electrode.

14. The electrode arrangement according to claim 1,
characterized by
its use in the foodstuff technology, for the surgical treatment of humans or animals, in the building industry for drying buildings or parts thereof, in the catering trade, for compacting and drying biological or chemical wastes, as well as in the field of heating and air-conditioning technology.
